(19) United States
(12) Patent Application Publication
(10) Pub. No.: US 2024/0128457 A1
(43) Pub. Date: Apr. 18, 2024

(54) BATTERY SLURRY, ELECTRODE PLATE AND LITHIUM BATTERY

(71) Applicant: XIAMEN HITHIUM ENERGY STORAGE TECHNOLOGY CO., LTD., Xiamen (CN)

(72) Inventors: Linping LIAO, Xiamen (CN); Shiwen WANG, Xiamen (CN); Lili YU, Xiamen (CN)

(21) Appl. No.: 18/533,120

(22) Filed: Dec. 7, 2023

Related U.S. Application Data
(63) Continuation of application No. PCT/CN2022/141319, filed on Dec. 23, 2022.

(30) Foreign Application Priority Data
May 11, 2022 (CN) 202210514539.3

(51) Int. Cl. H01M 4/62; H01M 4/04; H01M 4/583

(52) U.S. Cl. CPC H01M 4/621; H01M 4/0404; H01M 4/583; H01M 2004/028

(57) ABSTRACT

A battery slurry, an electrode plate and a lithium battery are provided. The battery slurry includes an aqueous binder and an organic additive. The organic additive includes at least one of —NHR and —SH, where R is alkyl.

### CROSS-REFERENCE TO RELATED APPLICATION

This application is a continuation of International Application No. PCT/CN2022/141319, filed on Dec. 23, 2022, which claims priority to Chinese patent application No. 202210514539.3, filed with China National Intellectual Property Administration on May 11, 2022 and entitled “BATTERY SLURRY, POSITIVE ELECTRODE PLATE, NEGATIVE ELECTRODE PLATE AND LITHIUM BATTERY”, the content of which is incorporated herein by reference in its entirety.

### TECHNICAL FIELD

The present disclosure belongs to the field of lithium batteries, and in particular, to a battery slurry, an electrode plate, and a lithium battery.

### BACKGROUND

An aqueous binder for a lithium battery has the characteristics of low cost and environmental friendliness, but its use is limited by hard and brittle electrode plates caused during the process of preparing the electrode plates. In view of the hard and brittle electrode plates caused by the aqueous binder, powder falls from the plate, and is easily introduced into the battery, resulting in internal short-circuit and even fire and explosion.

### SUMMARY

According to an embodiment of the present disclosure, a battery slurry includes an aqueous binder and an organic additive. The organic additive includes at least one of —NHR and —SH, where R is alkyl.

According to a second aspect of the present disclosure, the present disclosure provides an electrode plate. According to an embodiment of the present disclosure, the electrode plate includes a current collector and an active material layer formed on a surface of the current collector. The electrode active material layer is formed from the battery slurry.

According to a third aspect of the present disclosure, the present disclosure provides a lithium battery. According to an embodiment of the present disclosure, the lithium battery includes the electrode plate. Therefore, the lithium battery has excellent cycle performance.

The additional aspects and advantages of the present disclosure will be partially provided in the following description, and will partially become obvious from the following description, or be learned through the practice of the present disclosure.

### DESCRIPTION OF EMBODIMENTS

The embodiments detailed below are intended to explain the present disclosure, rather than being construed as limitation to the present disclosure.

According to an aspect of the present disclosure, the present disclosure provides a battery slurry. In an embodiment of the present disclosure, the battery slurry includes an aqueous binder and an organic additive. The organic additive has at least one of —NHR and —SH, and R is alkyl.

The inventors have found that, by adding the aqueous binder and the organic additive (the organic additive includes at least one group of —NHR and —SH) to the battery slurry, the organic additive of the battery slurry has polar functional groups, and can interact with active materials of the aqueous binder such as carboxyl groups and ester groups to generate intermolecular forces, thereby achieving uniform dispersion of the active materials. Meanwhile, during a coating drying process, the organic additive with —NHR and/or —SH interacts with the aqueous binder to resist a stress generated by the evaporation of a solvent during the drying process so that a film surface is unlikely to crack. In this way, the problem of hard and brittle electrode plates caused by the use of existing binders can be effectively solved. In addition, a thick coating is unlikely to crack, a cold-pressed electrode plate is unlikely to break, powder is unlikely to fall in die-cutting and winding processes, and a powder falling rate of the folded electrode plate is smaller than 5.47 wt %), thereby avoiding short-circuit inside a battery, and even fire, explosion, and other safety accidents. For example, the organic additive has both —NHR and —SH groups. That is, a mixture of an organic additive having —NHR groups and an organic additive having —SH groups is used. The —NHR groups mainly provide an electrostatic dispersion function. The —SH groups are prone to esterification and are more likely to react with the aqueous binder during the coating drying stage, thereby providing a partial cross-linking function, resisting the stress caused by uneven drying of the solvent, and preventing the film surface from cracking.

In an embodiment of the present disclosure, a mass ratio of the aqueous binder to the organic additive in the battery slurry is 22:(0.5 to 2). The inventors have found that, if the addition amount of the aqueous binder is too low, a peeling force of the formed electrode plate is reduced, and powder fall off in the rolling, slitting, and winding processes; if the addition amount of the organic additive is too high, high cost is caused while part of small molecule additives cannot be baked out in the coating process, which may affect the cycle performance of a battery cell; and if the addition amount of the organic additive is too low, the flexibility of the film surface deteriorates. Further, a monomer of the aqueous binder includes, but is not limited to at least one of acrylate, acrylic acid, acrylonitrile, or acrylamide. The organic additive includes, but is not limited to at least one of N-methylacetamide, triethylamine, acetamide, ethylenediamine, ethanethiol, 1,2-ethanedithiol, or polythiol, e.g., 1,2-ethanedithiol and amide small molecules.

In an embodiment of the present disclosure, the battery slurry is a positive electrode slurry, and the positive electrode slurry includes a positive electrode active material, a conductive agent, the aqueous binder, and the organic additive. A mass ratio of the positive electrode active material, the conductive agent to a sum of the aqueous binder and the organic additive is (94 to 98):(0.5 to 6):(2 to 5). The inventors have found that, if the addition amount of the positive electrode active material is too low, the amount of main materials in the battery slurry formula will be less, resulting in a low battery cell capacity. Further, the film surface is harder and more brittle, and the rolling is broken. If the addition amount of the positive electrode active material is excessive, a peeling force of the formed electrode plate is reduced, and powder fall off in the rolling, slitting, and winding processes. It may be noted that, those skilled in the art may select the specific kinds of the positive electrode active material and the conductive agent based on actual needs. For example, the positive electrode active material is lithium iron phosphate, and the conductive agent includes at least one of carbon nanotubes, graphene, or conductive carbon black.

In a further embodiment of the present disclosure, the battery slurry is a negative electrode slurry, and the negative electrode slurry includes graphite, a conductive agent, the aqueous binder, and the organic additive. A mass ratio of the graphite, a mass of the conductive agent and a sum of the aqueous binder and the organic additive is (94 to 98):(0.5 to 6):(2 to 5). The inventors have found that, if the addition amount of the graphite is too low, the amount of main materials in the battery slurry formula will be less, resulting in a low energy density of the battery cell, and further, the film surface is more hard and brittle and the rolling is broken; and if the addition amount of the graphite is too high, a peeling force of the formed electrode plate is reduced, and powder fall off in the rolling, slitting, and winding processes. It should be noted that, those skilled in the art may select the specific kind of the conductive agent based on actual needs. For example, the conductive agent includes at least one of carbon nanotubes, graphene, or conductive carbon black.

According to a second aspect of the present disclosure, the present disclosure provides a positive electrode plate. In an embodiment of the present disclosure, the positive electrode plate includes a positive electrode current collector and a positive electrode active material layer. The positive electrode active material layer is formed on a surface of the positive electrode current collector, and is formed from the positive electrode slurry.

Therefore, the positive electrode slurry is coated on the surface of the positive electrode current collector to form the positive electrode plate. The organic additive in the positive electrode slurry has polar functional groups, and thus can interact with carboxyl and ester group of the aqueous binder, as well as the conductive agent, the positive electrode active material and the like to generate intermolecular forces, thereby achieving uniform dispersion of the positive electrode active material. Meanwhile, during the coating drying process, the organic additive with —NHR and/or —SH interacts with the aqueous binder to resist the stress caused by the evaporation of the solvent during the drying process, such that the film surface is unlikely to crack. Therefore, the positive electrode plate has flexibility and toughness while maintaining excellent bonding performance, such that the problem of hard and brittle electrode plates caused by the use of existing binders can be effectively solved. In addition, a thick coating is unlikely to crack, a cold-pressed electrode plate is unlikely to break, powder is unlikely to fall in die-cutting and winding processes, and a powder falling rate of the folded electrode plate is smaller than 5.47 wt %), thereby avoiding short-circuit inside a battery, and even fire, explosion, and other safety accidents.

It should be noted that, the characteristics and advantages described above for the battery slurry are also applicable to the positive electrode plate, which will not be repeated herein.

According to a third aspect of the present disclosure, the present disclosure provides a negative electrode plate. In an embodiment of the present disclosure, the negative electrode plate includes a negative electrode current collector and a negative electrode active material layer. The negative electrode active material layer is formed on a surface of the negative electrode current collector, and is formed from the above negative electrode slurry.

Therefore, the negative electrode slurry is coated on the surface of the negative electrode current collector to form the negative electrode plate. The organic additive in the negative electrode slurry has polar functional groups, and thus can interact with carboxyl and ester group of the aqueous binder, the negative electrode active material and the like to generate intermolecular forces, thereby achieving uniform dispersion of the negative electrode active material. Meanwhile, during the coating drying process, the organic additive with —NHR and/or —SH interacts with the aqueous binder to resist the stress caused by the evaporation of the solvent during the drying process, such that the film surface is unlikely to crack. Therefore, the negative electrode plate has flexibility and toughness while maintaining excellent bonding performance, such that the problem of hard and brittle electrode plates caused by the use of existing binders can be effectively solved. In addition, a thick coating is unlikely to crack, a cold-pressed electrode plate is unlikely to break, powder is unlikely to fall in die-cutting and winding processes, and a powder falling rate of the folded electrode plate is smaller than 5.47 wt %), thereby avoiding short-circuit inside a battery, and even fire, explosion, and other safety accidents.

It should be noted that, the characteristics and advantages described above for the battery slurry are also applicable to the negative electrode plate, which will not be repeated herein.

According to a fourth aspect of the present disclosure, the present disclosure provides a lithium battery. In an embodiment of the present disclosure, the lithium battery includes the positive electrode plate and/or the negative electrode plate. Therefore, the lithium battery has excellent cycle performance.

It should be noted that, the characteristics and advantages described above for the positive electrode plate and/or the negative electrode plate are also applicable to the lithium battery, which will not be repeated herein.

The Examples of the present disclosure are described in detail below. It should be noted that, the examples described below are exemplary only, and are only intended to explain the present disclosure, rather than being construed as limitation to the present disclosure. Further, if not expressly stated, all reagents employed in the following examples are commercially available, or may be synthesized in accordance with the method of the present disclosure or known methods. Conditions that are not listed are also readily available to those skilled in the art.

### Example 1

A positive electrode slurry includes 95 wt % of lithium iron phosphate, 2 wt % of binder, and 3 wt % of conductive carbon black. The binder includes an aqueous binder of acrylate-acrylic acid-acrylonitrile-acrylamide and an organic additive of acetamide, and a mass ratio of the aqueous binder to the organic additive is 22:1.

A method of preparing a positive electrode plate includes coating the positive electrode slurry on two surfaces of an aluminum foil and rolling the aluminum foil after the completion of coating, to form a positive electrode active material layer on the surfaces of the aluminum foil. A coating weight is in a range of 147 g/m² to 165 g/m².

A method of preparing a battery cell includes assembling the battery cell by taking the positive electrode plate as a positive electrode, taking graphite as a negative electrode, taking a mixed solution containing lithium hexafluorophosphate, vinyl carbonate, dimethyl carbonate, methyl ethyl carbonate, and various additives as an electrolytic solution (lithium hexafluorophosphate has a concentration of 1 moL/L), and taking a PP separator as a separator.

### Example 2

The aqueous binder is acrylate-acrylic acid-acrylonitrile-acrylamide, the organic additive is 1,2-ethanedithiol, and the rest is the same as Example 1.

### Example 3

The aqueous binder is acrylate-acrylic acid-acrylonitrile-acrylamide, the organic additive includes a mixture of 1,2-ethanedithiol and acetamide, and the rest is the same as Example 1.

### Comparative Example

There is no organic additive to be added, and the rest is the same as Example 1.

The production condition, peeling force and powder falling rate during winding of the positive electrode plates in Examples 1 to 3 and Comparative Example, as well as the cycle performances of the batteries in Examples 1 to 3 and Comparative Example are evaluated, and the specific characterization results are shown in Tables 1 to 2.

TABLE 1
Production condition, peeling force and powder falling rate during winding
of the positive electrode plates in Examples 1 to 3 and Comparative Example

| | | | | | Powder falling |
|---|---|---|---|---|---|
| | | Solid content | | Peeling | rate during |
| | Production condition | in slurry | | force | winding |
| Example 1 | The coating is not cracked, and the | 64.5 | wt % | 8.5 N/m | 4.98% |
| | positive electrode plate can be normally | | | | |
| | rolled and slitted. | | | | |
| Example 2 | The coating is not cracked, and the | 67.1 | wt % | 10.2 N/m | 4.50% |
| | positive electrode plate can be normally | | | | |
| | rolled and sliced. | | | | |
| Example 3 | The coating is not cracked, and the | 68.8 | wt% | 9.7 N/m | 4.2% |
| | positive electrode plate can be normally | | | | |
| | rolled and sliced. | | | | |
| Comparative | The coating is cracked and the rolling is | 62 | wt% | 8.3 N/m | 5.47 wt % |
| Example | broken frequently, the positive electrode | | | | |
| | plate is sliced manually, rather than | | | | |
| | being sliced on a slitter. | | | | |

TABLE 2
Cycle performance of the batteries
in Examples 1 to 3 and Comparative

| | Capacity retention rate after |
|---|---|
| | 2000 cycles |
| Example 1 | 83.11% |
| Example 2 | 84.14% |
| Example 3 | 83.27% |
| Comparative Example | 82.15% |

A method of testing the powder falling rate during the winding includes: (1) weighing an electrode plate to obtain Y; (2) winding the electrode plate by a manual winding machine; (3) placing the wound electrode plate on a glass fixture; (4) gently brushing off the powder and material falling from the electrode plate by a soft brush; (5) weighing the wound electrode plate from which the powder has been brushed away, to obtain a weight Z after winding; and (6) calculating a powder falling rate through an equation X=(Y−Z)/Y×100%.

In the description of the present specification, the description of referring terms, such as “an embodiment”, “some embodiments”, “an example”, “a specific example” and “some examples”, integrate particular features, structures, materials or characteristics described in combination of the embodiments or examples and included in at least one embodiment or example of the present disclosure. In the description, schematic description of the above terms does not necessarily refer to the same embodiment or example. Furthermore, the described particular features, structures, materials or characteristics can be integrated with any one or more embodiments or examples in a proper manner. In addition, in the absence of contradiction, those skilled in the art can integrate and combine different embodiments or examples described in this specification and the features of different embodiments or examples.

The embodiments of the present disclosure are described above in conjunction with the accompanying drawings, but the present disclosure is not limited to the above specific embodiments. The above specific embodiments are only exemplary rather than limiting. Under the enlightenment of the present application, those skilled in the art can make many forms without departing from the purpose of the present disclosure and the scope of the claims, all of which fall within the scope of the present disclosure.

What is claimed is:

1. A battery slurry, comprising an aqueous binder and an organic additive, wherein the organic additive comprises at least one of —NHR and —SH, where R is alkyl.

2. The battery slurry according to claim 1, wherein a mass ratio of the aqueous binder to the organic additive is 22:(0.5 to 2).

3. The battery slurry according to claim 1 wherein a monomer of the aqueous binder comprises at least one of acrylate, acrylic acid, acrylonitrile, or acrylamide.

4. The battery slurry according to claim 1, wherein the organic additive comprises at least one of N-methylacetamide, triethylamine, acetamide, ethylenediamine, ethanethiol, 1,2-ethanedithiol, or polythiol.

5. The battery slurry according to claim 1, wherein the battery slurry is a positive electrode slurry, and the positive electrode slurry comprises a positive electrode active material, a conductive agent, the aqueous binder, and the organic additive.

6. The battery slurry according to claim 5, wherein a mass ratio of the positive electrode active material, the conductive agent to a sum of the aqueous binder and the organic additive is (94 to 98):(0.5 to 6):(2 to 5).

7. The battery slurry according to claim 1, wherein the battery slurry is a negative electrode slurry, and the negative electrode slurry comprises graphite, a conductive agent, the aqueous binder, and the organic additive.

8. The battery slurry according to claim 7, wherein a mass ratio of the graphite, the conductive agent to a sum of the aqueous binder and the organic additive is (94 to 98):(0.5 to 6):(2 to 5).

9. An electrode plate, comprising:
a current collector; and
an active material layer formed on a surface of the current collector, the active material layer being formed from a battery slurry comprising an aqueous binder and an organic additive, wherein the organic additive comprises at least one of —NHR and —SH, where R is alkyl.

10. The electrode plate according to claim 9, wherein a mass ratio of the aqueous binder to the organic additive is 22:(0.5 to 2).

11. The electrode plate according to claim 9, wherein a monomer of the aqueous binder comprises at least one of acrylate, acrylic acid, acrylonitrile, or acrylamide.

12. The electrode plate according to claim 9, wherein the organic additive comprises at least one of N-methylacetamide, triethylamine, acetamide, ethylenediamine, ethanethiol, 1,2-ethanedithiol, or polythiol.

13. The electrode plate according to claim 9, wherein the current collector is a positive electrode current collector, the active material layer is a positive electrode active material layer; the battery slurry is a positive electrode slurry, and the positive electrode slurry comprises a positive electrode active material, a conductive agent, the aqueous binder, and the organic additive.

14. The electrode plate according to claim 13, wherein a mass ratio of the positive electrode active material, the conductive agent to a sum of the aqueous binder and the organic additive is (94 to 98):(0.5 to 6):(2 to 5).

15. The electrode plate according to claim 9, wherein the current collector is a negative electrode current collector, the active material layer is a negative electrode active material layer; the battery slurry is a negative electrode slurry, and the negative electrode slurry comprises graphite, a conductive agent, the aqueous binder, and the organic additive.

16. The electrode plate according to claim 15, wherein a mass ratio of the graphite, the conductive agent to a sum of the aqueous binder and the organic additive is (94 to 98):(0.5 to 6):(2 to 5).

17. A lithium battery, comprising an electrode plate, the electrode plate comprising
a current collector; and
an active material layer formed on a surface of the current collector, the active material layer being formed from a battery slurry comprising an aqueous binder and an organic additive, wherein the organic additive comprises at least one of —NHR and —SH, where R is alkyl.

18. The lithium battery according to claim 17, wherein the current collector is a positive electrode current collector, the active material layer is a positive electrode active material layer; the battery slurry is a positive electrode slurry, and the positive electrode slurry comprises a positive electrode active material, a conductive agent, the aqueous binder, and the organic additive.

19. The lithium battery according to claim 17, wherein the current collector is a negative electrode current collector, the active material layer is a negative electrode active material layer; the battery slurry is a negative electrode slurry, and the negative electrode slurry comprises graphite, a conductive agent, the aqueous binder, and the organic additive.
